(19) United States
(12) Patent Application Publication
(10) Pub. No.: US 2006/0238481 A1
(43) Pub. Date: Oct. 26, 2006

(54) Liquid crystal display device

(75) Inventor: Takuya Uehara, Osaka (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-Shi (JP)

(21) Appl. No.: 11/410,835

(22) Filed: Apr. 26, 2006

(30) Foreign Application Priority Data
Apr. 26, 2005 (JP) 2005-127734

(51) Int. Cl. G09G 3/36

(52) U.S. Cl. 345/99

(57) ABSTRACT

In an LCD device, a driver circuit board for outputting signals to source driver ICs and gate driver ICs is placed at a position on a cover panel distant from a position on the cover panel at which an inverter control board for cathode ray tubes is placed. The driver board is connected by first FFCs to a source bus board having the source ICs mounted thereon, and is further connected by a second FFC to a gate bus board having the gate ICs mounted thereon. The second FFC extends via a ridgeline formed between a top surface and a side surface of a liquid crystal panel. The signals from the driver board to the gate ICs are provided via the first FFCs, the source board, the second FFC and the gate board. This LCD device has improved layout flexibility and facilitates a change of placement of e.g. a backlight.

### BACKGROUND OF THE INVENTION

1. Field of the Invention

The present invention relates to a liquid crystal display device, and more particularly to a structure for connecting source driver ICs and gate driver ICs to a liquid crystal panel, and connecting a driver circuit board to both the driver ICs to control their timing.

2. Description of the Related Art

In an active matrix type liquid crystal display (LCD) device, source terminals connected to source electrodes of thin film transistors and gate terminals connected to gate electrodes of the thin film transistors are respectively formed on two adjacent sides of a liquid crystal panel. The source terminals and the gate terminals are respectively connected via driver ICs (integrated circuits) to a driver circuit. The driver circuit provides image signals and line scan signals (control signals) to the source terminals and the gate terminals, respectively, by adjusting the timing of both signals so as to form a predetermined image on a liquid crystal panel.

Generally, the driver circuit is connected via bus (cable) wiring to the respective driver ICs. More specifically, horizontal and vertical buses in a matrix array for connecting the driver circuit to the respective driver ICs are provided on a rear surface of the liquid crystal panel. This will be described in detail below with reference to FIGS. 3A, 3B and 3C.

FIGS. 3A, 3B and 3C show a top plan view, a rear view and a side view, respectively, of a conventional LCD device 51. The LCD device 51 comprises: a liquid crystal panel 52; a metal-made cover panel 53 for covering substantially the entire rear surface of the liquid crystal panel 52; a backlight contained in the cover panel 53 and comprised of U-shaped cathode ray tubes 54; source driver ICs 55 provided on a top surface 52a of the liquid crystal panel 52 and connected to the liquid crystal panel 52; gate driver ICs 56 provided on a side surface 52b of the liquid crystal panel 52 and connected to the liquid crystal panel 52; a source bus board 57 connected to the source driver ICs 55; and a gate bus board 58 connected to the gate driver ICs 56. These source bus board 57 and gate bus board 58 are connected to a driver circuit board 59 placed and fixed on the cover panel 53 via FFCs (Flat Flexible Cables) 61 and 62, respectively. Further, an inverter control board 63 for controlling the cathode ray tubes 54 is fixed on the cover panel 53. Note that generally the inverter control board 63 is placed in an above-center position on the cover panel 53, because the brightness of the entire screen based on the cathode ray tubes 54 can be more easily controlled by applying the inverter control to upper ones of the cathode ray tubes 54.

Since the source bus board 57 and the gate bus board 58 are provided on the top surface 52a and the side surface 52b, respectively, of the liquid crystal panel 52, it is a natural consequence that the FFCs 61 connecting the source bus board 57 to the driver circuit board 59 and the FFC 62 connecting the gate bus board 58 to the driver circuit board 59 are respectively provided to extend vertically and horizontally on or over the cover panel 53. Thus, a most efficient position of the driver circuit board 59 is an upper right position on the cover panel 53 in the rear view as shown in FIG. 3B. However, at the same time, the possible position of the driver circuit board 59 is substantially limited to such upper right position on the cover panel 53, resulting in poor layout flexibility, for the following reason.

For example, when the U-shaped cathode ray tubes 54 in the LCD device 1 are reversed left to right for the purpose of making uniform the brightness of the screen or for other purposes, then connectors 54a of the cathode ray tubes 54 are positioned on the right side in FIG. 3B. Thus, it becomes necessary to place the inverter control board 63 in a right-of-center position on the cover panel 53. In this case, if the driver circuit board 59 is placed in a left-of-center position on the cover panel 53 in order to avoid interference between the driver circuit board 59 and the inverter control board 63, the FFC 62 extending horizontally to connect the driver circuit board 59 to the gate bus board 58 becomes very long, making it troublesome to handle. In addition, in such case, the FFC 62 either passes near or straddles the inverter control board 63, so that there is a possibility that noise is superimposed on the signals sent from the driver circuit board 59 to the gate driver ICs 56 via the FFC 62.

There are known technologies of LCD devices, which use flexible connections to connect a driver circuit to driver ICs. For example, Japanese Laid-open Patent Publication 2004-4924 (Japanese Patent 3575482) discloses to use flexible circuit boards to facilitate assembly when connecting driver ICs to a driver circuit, in which at least two flexible circuit boards are required for sources and gates. For cable connection between the two or more flexible circuit boards, this Patent Publication teaches to provide wiring connections between two adjacent flexible circuit boards positioned perpendicular to each other and provided on two adjacent intersecting sides of a liquid crystal panel.

On the other hand, Japanese Laid-open Patent Publication Hei 1-234829 (Japanese Patent 2504106) discloses to use film-like connecting members to connect driver circuit modules having driver ICs to sides of a liquid crystal panel of an LCD device. Because of the use of the film-like connecting members, the driver circuit modules can be placed on side surfaces of the liquid crystal panel which are perpendicular to the main surface of the liquid crystal panel. This prevents the LCD device from having a very large outer size due to the driver circuit modules.

However, such known technologies as disclosed in these Patent Publications do not lead to a solution to improve layout flexibility of laying out elements in an LCD device such as a driver circuit board and an inverter control board, or to facilitate a change of placement of e.g. a backlight.

### SUMMARY OF THE INVENTION

An object of the present invention is to provide an LCD device that is improved in structure for connecting a driver circuit board to source driver ICs and gate driver ICs so as to improve layout flexibility and facilitate a change of placement of e.g. a backlight.

According to the present invention, this object is achieved by a liquid crystal display device comprising: a liquid crystal panel; a cover panel for covering substantially an entire rear surface of the liquid crystal panel; a backlight contained in the cover panel; a film-like source bus board and a film-like gate bus board which are placed on two adjacent sides of the cover panel; source driver integrated circuits (hereafter referred to as “ICs”) mounted on the source bus board; gate driver ICs mounted on the gate bus board; a driver circuit board for controlling timing of the source driver ICs and the gate driver ICs; a first flexible cable for connecting the driver circuit board to the source bus board; and a second flexible cable placed-on the two adjacent sides of the cover panel for connecting the source bus board to the gate bus board.

According to the present invention, the flexibility of layout (flexibility of positions to place respective components) is improved, facilitating a design such as a change of placement of e.g. a backlight in an LCD device which comprises: a liquid crystal panel; a cover panel for covering substantially the entire rear surface of the liquid crystal panel; a backlight contained in the cover panel; source driver ICs and gate driver ICs connected to the liquid crystal panel on two adjacent sides of the liquid crystal panel, respectively; and a driver circuit board connected to both driver ICs via bus wirings, respectively. Furthermore, the connection structure can be simplified, resulting in a higher probability of reducing manufacturing cost.

Preferably, the second flexible cable extends between and is connected to the source bus board and the gate bus board, extending via a ridgeline at a corner of the liquid crystal panel formed where the two adjacent sides of the liquid crystal panel intersect.

Further preferably, the liquid crystal display device further comprises an inverter control board placed on the cover panel for controlling the backlight, wherein the driver circuit board is placed at a position on the cover panel distant from a position on the cover panel at which the inverter control board is placed.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIGS. 1A, 1B and 1C are a top plan view, a rear view and a side view, respectively, of a liquid crystal display (LCD) device according to an embodiment of the present invention;

FIG. 2 is a perspective view of a portion of the LCD device in the case where a top surface and a side surface of a cover panel intersect at, and thereby form, a tilted ridgeline; and

FIGS. 3A, 3B and 3C are a top plan view, a rear view and a side view, respectively, of a conventional LCD.

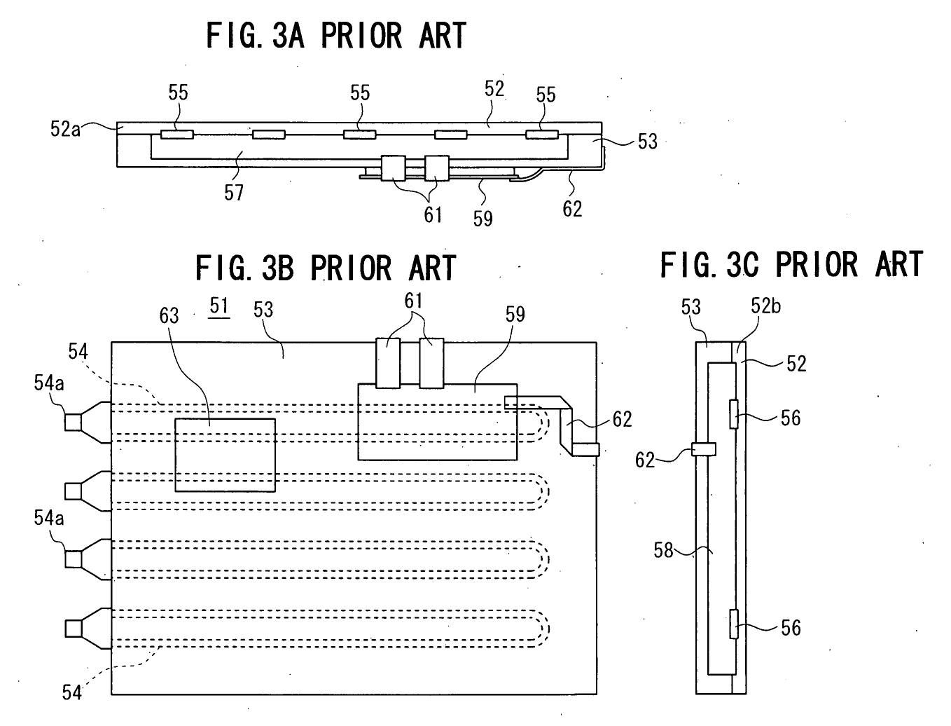

### DESCRIPTION OF THE PREFERRED EMBODIMENTS

The best modes and preferred embodiments of the present invention will be described hereinafter with reference to the annexed drawings. The specific embodiments described are not intended to cover the entire scope of the present invention, and hence the present invention is not limited to only the specific embodiments. Note that like parts are designated by like reference numerals or reference characters throughout the drawings.

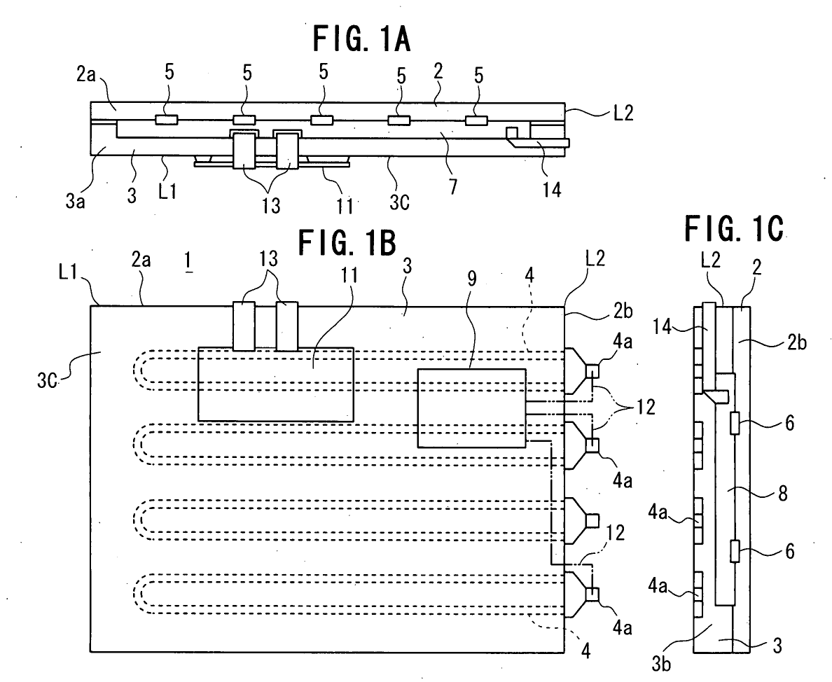

Referring to FIGS. 1A, 1B and 1C, a liquid crystal display (LCD) device 1 according to an embodiment of the present invention will be described. FIGS. 1A, 1B and 1C show a top plan view, a rear view and a side view, respectively, of the LCD device 1. The LCD device 1 comprises: a liquid crystal panel 2; a metal-made cover panel 3 for covering substantially the entire rear surface of the liquid crystal panel 2; a backlight contained in the cover panel 3 and comprised of U-shaped cathode ray tubes 4; source driver ICs 5 provided on a top surface 2a of the liquid crystal panel 2 and connected to the liquid crystal panel 2; gate driver ICs 6 provided on a side surface 2b of the liquid crystal panel 2 and connected to the liquid crystal panel 2; a source bus board 7 having the source driver ICs 5 mounted thereon and connected thereto; and a gate bus board 8 having the gate driver ICs 6 mounted thereon and connected thereto.

The source bus board 7 and the gate bus board 8 are formed of flexible boards with source bus and gate bus provided thereon, respectively. Each of the flexible boards is an elongated rectangular-shaped and film-like board, which is generally referred to as an FPC (Flexible Printed Circuit). The source driver ICs 5 and the gate driver ICs 6 are respectively mounted on and connected to the source bus board 7 and the gate bus board 8 by so-called TAB (Tape Automated Bonding) or COF (Chip on Film). The source bus board 7 and the gate bus board 8 are placed on two adjacent sides of the cover panel 3. More specifically, the source bus board 7 and the gate bus board 8 are in intimate contact with and along a top surface 3a and a side surface 3b, respectively, of the cover panel 3. Note that since the source driver ICs 5 and the gate driver ICs 6 formed by the TAB or COF become more expensive in proportion to the lengths of the flexible boards, it is desirable to reduce the lengths of the flexible boards.

In the LCD device 1 of the present embodiment, the cathode ray tubes 4 are placed such that connectors 4a of the cathode ray tubes 4 are positioned on the right side in the rear view as shown in FIG. 1B, while an inverter control board 9 for controlling the cathode ray tubes 4 is placed and fixed at an upper right position, in the rear view as shown in FIG. 1B, on a major surface 3c of the cover panel 3 which is on the rear side or rear surface of the LCD device. The inverter control board 9 is placed at a position on the cover panel 3 near the gate driver ICs 6. Further, a driver circuit board 11 for sending signals to the source driver ICs 5 and the gate driver ICs 6 is placed at a left upper position on the major surface 3c of the cover panel 3 to avoid interference between the inverter control board 9 and connection wirings 12 which connect the inverter control board 9 to the cathode ray tubes 4.

The driver circuit board 11 controls timing of the source driver ICs 5 and the gate driver ICs 6, more specifically adjusts timing of image signals and line scan signals (control signals), and provides the timing-adjusted image signals and line scan signals to the source driver ICs 5 and the gate driver ICs 6, respectively, so as to form a predetermined image on a screen of the liquid crystal panel 2. The following describes a structure for connecting the driver circuit board 11 to the respective driver ICs 5 and 6.

Two first flexible cables (Flat Flexible Cables, hereafter referred to as FFCs) 13 extend between and are connected to the driver circuit board 11 and the source bus board 7, extending via a ridgeline L1 at a corner of the liquid crystal panel 2 formed where the adjacent top surface 3a and major surface 3c of the cover panel 3 intersect. On the other hand, a second flexible cable (FFC) 14 extends between and is connected to the source bus board 7 and the gate bus board 8, extending via a further ridgeline L2 at a further corner of the liquid crystal panel 2 formed where the adjacent top surface 2a and side surface 2b of the liquid crystal panel 2 intersect, and where the adjacent top surface 3a and side surface 3b of the cover panel 3 intersect. Since the first FFCs 13 and the second FFC 14 all have sufficient flexibility, they can be placed on and along the respective surfaces of the LCD device 1 via the ridgelines L1 and L2 without difficulty.

More specifically, despite the existence of the ridgelines L1 and L2 at the comers of the liquid crystal panel 2 or the cover panel 3, the first FFCs 13 are in contact with the major surface 3c and top surface 3a of the cover panel 3 via the ridgeline L1, while the second FFC 14 is in contact with the top surface 2a and side surface 2b of the liquid crystal panel 2, as well as the top surface 3a and side surface 3b of the cover panel 3, via the ridgeline L2. This is due to the flexibility of the first and second FFCs 13 and 14. Besides, note that although two of the first FFCs 13 are used here to provide e.g. images signals and, line scan signals (control signals) from the driver circuit board 11 to the source bus board 7, it can be readily devised as one first FFC (one first flexible cable) for the same purpose.

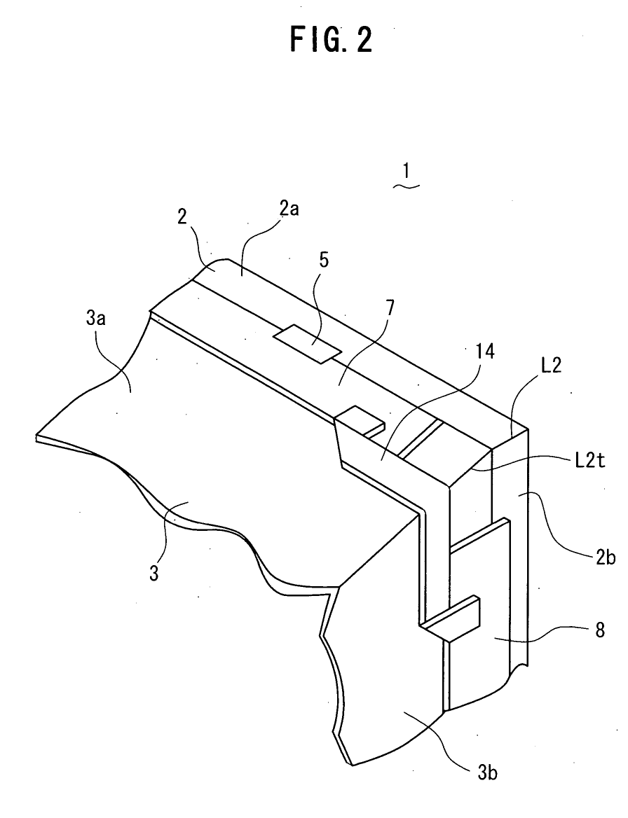

Further note that if the backlight has a large structure to cause the thickness (front-to-rear width) of the cover panel 3 to be large, the entire cover panel 3 may become trapezoidal in shape. FIG. 2 is a perspective view of a portion of an LCD device 1 in the case where a top surface 3a and a side surface 3b of a cover panel 3 intersect at, and thereby form, a ridgeline L2t which is tilted from an original ridgeline L2 formed between a top surface 2a and a side surface 2b of a liquid crystal panel 2. As shown in FIG. 2, for example, the ridgeline L2t between the adjacent top surface 3a and side surface 3b of the cover panel 3 may be tilted from the original ridgeline L2. However, even in this case, a second FFC 14 can be placed on and along the top surface 3a and side surface 3b of the cover panel 3 via the ridgeline L2t without difficulty, since the second FFC 14 has sufficient flexibility.

Referring back to FIGS. 1A to 1C, e.g. the image signals sent or provided from the driver circuit board 11 are input to the source driver ICs 5 via the first FFCs 13 and the source bus board 7, while e.g. the line scan signals sent or provided from the driver circuit board 11 are input to the gate driver ICs 6 via the first FFCs 13, the source bus board 7, the second FFC 14 and the gate bus board 8. Thus, the control signals input from the driver circuit board 11 to the gate driver ICs 6 pass through paths sufficiently distant from the inverter control board 9 and from the connection wirings 12 which connect the inverter control board 9 to the cathode ray tubes 4. Accordingly, there is little possibility that noise is superimposed from e.g. the inverter control board 9 and the connection wirings 12 onto the control signals sent from the driver circuit board 11 so as to degrade the control signals. Besides, the inverter control board 9 can be placed at a position on the cover panel 3 near the gate driver ICs 6.

As described above, the electrical connection from the driver circuit board 11 to the bus boards 7 and 8 is made via the first FFCs 13 (first flexible cable), forming a single or only output path from the major surface 3c of the cover panel 3, and extending vertically to the ridgeline L1 along the major surface 3c of the cover panel 3. Thus, signals to be provided from the driver circuit board 11 to the gate bus board 8 are also once output through the first FFCs 13, more specifically, through the first FFCs 13, the source bus board 7 and the second FFC 14. That is, the electrical connection from the source bus board 7 to the gate bus board 8 is made via the second FFC 14.

Accordingly, the driver circuit board 11 can be easily placed at an optional position on the major surface 3c of the cover panel 3. In the case of the example described above, even though the inverter control board 9 for controlling the cathode ray tubes 4 is placed at an upper right position of the cover panel 3, the driver circuit board 11 can be placed at an optional upper left position on the major surface 3c of the cover panel 3 without any need to consider the signal transmission path from the driver circuit board 11 to the gate driver ICs 6. Furthermore, the connection structure according to the present embodiment enables simple wiring connections, reducing manufacturing cost.

It is to be noted that the present invention is not limited to the above embodiments, and various modifications are possible. For example, flexible cables (cables having flexibility) such as FPCs other than FFCs can be used for the first FFCs (or FFC) 13 to connect the driver circuit board 11 to the source bus board 7, and for the second FFC 14 to connect the source bus board 7 to the gate bus board 8. Further, in addition to the function of outputting signals to the source driver ICs 5 and gate driver ICs 6 by adjusting the timing of both signals, the driver circuit board 11 can have a function of generating image signals to be output to the source driver ICs 5. In short, the driver circuit board 11 can be a circuit board which is connected in common to the source driver ICs 5 and the gate driver ICs 6, and which has a function of outputting timing control signals to both driver ICs 5 and 6.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

This application is based on Japanese patent application 2005-127734 filed Apr. 26, 2005, the content of which is hereby incorporated by reference.

What is claimed is:

1. A liquid crystal display device comprising:
a liquid crystal panel;
a cover panel for covering substantially an entire rear surface of the liquid crystal panel;
a backlight contained in the cover panel;
a film-like source bus board and a film-like gate bus board which are placed on two adjacent sides of the cover panel;
source driver integrated circuits (hereafter referred to as “ICs”) mounted on the source bus board;
gate driver ICs mounted on the gate bus board;
a driver circuit board for controlling timing of the source driver ICs and the gate driver ICs;
a first flexible cable for connecting the driver circuit board to the source bus board; and
a second flexible cable placed on the two adjacent sides of the cover panel for connecting the source bus board to the gate bus board.

2. The liquid crystal display device according to claim 1,
wherein the second flexible cable extends between and is connected to the source bus board and the gate bus board, extending via a ridgeline at a corner of the liquid crystal panel formed where the two adjacent sides of the liquid crystal panel intersect.

3. The liquid crystal display device according to claim 2,
which further comprises an inverter control board placed on the cover panel for controlling the backlight,
wherein the driver circuit board is placed at a position on the cover panel distant from a position on the cover panel at which the inverter control board is placed.

4. The liquid crystal display device according to claim 3,
wherein the inverter control board is placed at a position on the cover panel near the gate driver ICs.

5. The liquid crystal display device according to claim 4,
wherein control signals sent from the driver circuit board to the source driver ICs are provided to the source driver ICs via the first flexible cable and the source bus board, while control signals sent from the driver circuit board to the gate driver ICs are provided to the gate driver ICs via the first flexible cable, the source bus board, the second flexible cable and the gate bus board.

6. The liquid crystal display device according to claim 5,
wherein each of the first flexible cable and the second flexible cable is an FFC (Flat Flexible Cable).

7. The liquid crystal display device according to claim 1,
which further comprises an inverter control board placed on the cover panel for controlling the backlight,
wherein the driver circuit board is placed at a position on the cover panel distant from a position on the cover panel at which the inverter control board is placed.

8. The liquid crystal display device according to claim 7,
wherein the inverter control board is placed at a position on the cover panel near the gate driver ICs.

9. The liquid crystal display device according to claim 8,
wherein control signals sent from the driver circuit board to the source driver ICs are provided to the source driver ICs via the first flexible cable and the source bus board, while control signals sent from the driver circuit board to the gate driver ICs are provided to the gate driver ICs via the first flexible cable, the source bus board, the second flexible cable and the gate bus board.

10. The liquid crystal display device according to claim 9,
wherein each of the first flexible cable and the second flexible cable is an FFC (Flat Flexible Cable).

11. The liquid crystal display device according to claim 1,
wherein control signals sent from the driver circuit board to the source driver ICs are provided to the source driver ICs via the first flexible cable and the source bus board, while control signals sent from the driver circuit board to the gate driver ICs are provided to the gate driver ICs via the first flexible cable, the source bus board, the second flexible cable and the gate bus board.

12. The liquid crystal display device according to claim 1,
wherein each of the first flexible cable and the second flexible cable is an FFC (Flat Flexible Cable).
